(19) United States
(12) Patent Application Publication
(10) Pub. No.: US 2005/0005027 A1
(43) Pub. Date: Jan. 6, 2005

(54) Method and system for obtaining data through an IP transmission network by using an optimized domain name server

(75) Inventors: Francois-Xavier Drouet, Nice (FR); Gerard Marmigere, Drap (FR); Carole Truntschka, Saint-Laurent-Du-Var (FR)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/747,607

(22) Filed: Dec. 29, 2003

(30) Foreign Application Priority Data
Apr. 18, 2003 (EP) 03368032.3

(51) Int. Cl. G06F 15/16

(52) U.S. Cl. 709/245

(57) ABSTRACT

Data transmission system comprising at least a data transmission network based upon an IP protocol, at least a content server for providing data requested by a user connected to the network, a plurality of proxies having a cache function, each proxy capable of having stored the requested data and one of the proxies being a user proxy to which is addressed the request sent by the user, and a domain name server for converting a server name provided by the user to the user proxy into an IP address of the content server. The domain name server includes table means for providing an IP address of a proxy amongst the proxies capable of having stored the requested data, the table means providing the proxy IP address to the user proxy whereby the requested data can be provided to the user by the proxy storing the requested data without requesting the data from the content server.

### BACKGROUND OF THE INVENTION

1. Technical Field

The present invention relates generally to data transmission systems wherein a user can request through a transmission network data stored in a content server connected to the network. More particularly, the present invention relates to a method and system for obtaining data through an IP transmission network using an optimized domain name server.

2. Related Art

Today, service providers are able to provide users of the Internet network with a wide variety of data found in any one of numerous content servers accessible through the Web. In the Web context, the user has at his disposal a Web browser to access external content servers. The access by the browser is usually done through a proxy component generally located in the service provider platform, wherein the Web browser is forced to go through the proxy by configuration.

The response to a request for data from a user may take a long time, particularly in the case where the Web content server is connected through a network link with low performance or is heavy loaded. The requested data has to be transferred through the network at each request, thus requiring high network performance, especially if a large amount of data is transferred. One way to minimize the response time and to decrease the network loading is through the use of a proxy cache. The role of such a proxy cache is to intercept a request destined to a Web content server and to verify if the requested data is locally available in its cache, and, if this is the case, the local copy is used instead of the original data.

Typically, the proxy cache stores a particular page of data only after a user has requested it. However, specified URLs (pages or more generally Web objects) may be prefetched in the proxy cache before they have effectively been requested by a user. Such a cache refreshing may have several sources such as loading specific URLs defined by an administrator, loading the most popular URLs from the previous day's activity or following a specified level of HTML links on the loaded pages and caching all those linked pages.

The process of storing pages of data in a proxy cache dedicated to a user can be extended by using a set of proxy caches, all of them being able at any time to have stored data requested by a user. In such a case, however, insofar as the same page of data may be cached in several proxy caches, this results in a network and memory load since each proxy cache must download the page into its own cache.

Solutions exist to reduce the amount of data being downloaded. A first solution, the Internet Cache Protocol (ICP), is a Web caching protocol used to exchange hints about the existence of URLs in neighbor caches. The proxy caches exchange ICP queries and replies to gather information to use in selecting the most appropriate location from which to retrieve an object. The main issue is that it requires a lot of traffic between the proxy caches without any optimization or warranty of result. Also, there is no consistency between the caches, and information could also be duplicated.

Another solution, the Cache Array Routing Protocol (CARP), provides seamless scaling and extreme efficiency. CARP uses a hash-based routing to provide a deterministic “request resolution path” through an array of proxies. The request resolution path, based upon a hashing of proxy array member identities and URLs, means that, for any given URL request, the browser or downstream proxy will know exactly where in the proxy array the information will be stored, if already cached from a previous request, or will make a first Internet hit for delivery and caching.

Although the above solutions efficiently reduce the amount of information downloaded by a Web content server to the array proxy cache, such solutions have several important drawbacks. For example, with ICP, the queries for determining the location of the cached information generate extraneous network traffic. In addition, the array of proxy caches tend to become highly redundant over a period of time insofar as proxy caches contain the same URLs of the most frequently used sites. As far as CARP is concerned, it requires a special algorithm either in the Web browser on in a proxy to determine the localization of the requested data.

### SUMMARY OF THE INVENTION

Accordingly, the main object of the invention is to provide a method and system for determining, in an efficient way, whether there is a proxy cache amongst all of the proxy caches normally used in an IP network, which has previously stored requested data.

The present invention relates to a data transmission system comprising at least a data transmission network based upon an IP protocol, at least a content server for providing data requested by a user connected to the network, a plurality of proxies having a cache function, each proxy capable of having stored the requested data and one of the proxies being a user proxy to which is addressed the request sent by the user, and a domain name server for converting a server name provided by the user to the user proxy into an IP address of the content server. The domain name server includes table means for providing an IP address of a proxy amongst the proxies capable of having stored the requested data, the table means providing the proxy IP address to the user proxy whereby the requested data can be provided to the user by the proxy storing the requested data without requesting the data from the content server.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a block-diagram of a system for implementing the present invention.

FIG. 2 is a table of ODNS according to the invention.

FIG. 3 is a flow chart of the method steps implemented in an optimized domain name server according to the invention.

### DETAILED DESCRIPTION OF THE INVENTION

A system according to the invention is illustrated in FIG. 1.

In such a system, a user 10 is connected to the Internet network 12 and can obtain data from a content server 14. A plurality of proxy devices, such as proxy devices 16 or 18, are connected to the Internet network 12. These proxy servers are proxies having the cache function. This means that they store temporally data or HTML pages which are requested from a content server, such as content server 14, and which are transmitted to a user who has requested this data through the intermediary of the proxy. Note that, in the following discussion, the proxy will be used to designate any one of these proxies having the cache function. Amongst the proxies which are connected to the Internet network 12, it is assumed that one of them, for example, proxy 16, is the proxy server to which any request from user 10 for obtaining data is addressed. When the proxy 16 receives such a request from the user 10, it examines its cache to determine whether the requested data has been stored therein in answer to a previous request from the user 10 or any other user. If this is the case, the requested data is immediately returned by proxy 16 to the host of user 10. It should be noted that the data which has been sent to user 10 is kept in the cache of the proxy 16.

Assuming that the requested data or HTML pages are not stored in the proxy 16, a request is sent from proxy 16 to a domain name server (DNS) 20, to resolve the IP address of the server. The DNS 20 is optimized according to the principles of the invention. Such a DNS is a server which provides the IP address of the content server corresponding to the host name of the server, which is the name known by the user to designate the content server 14.

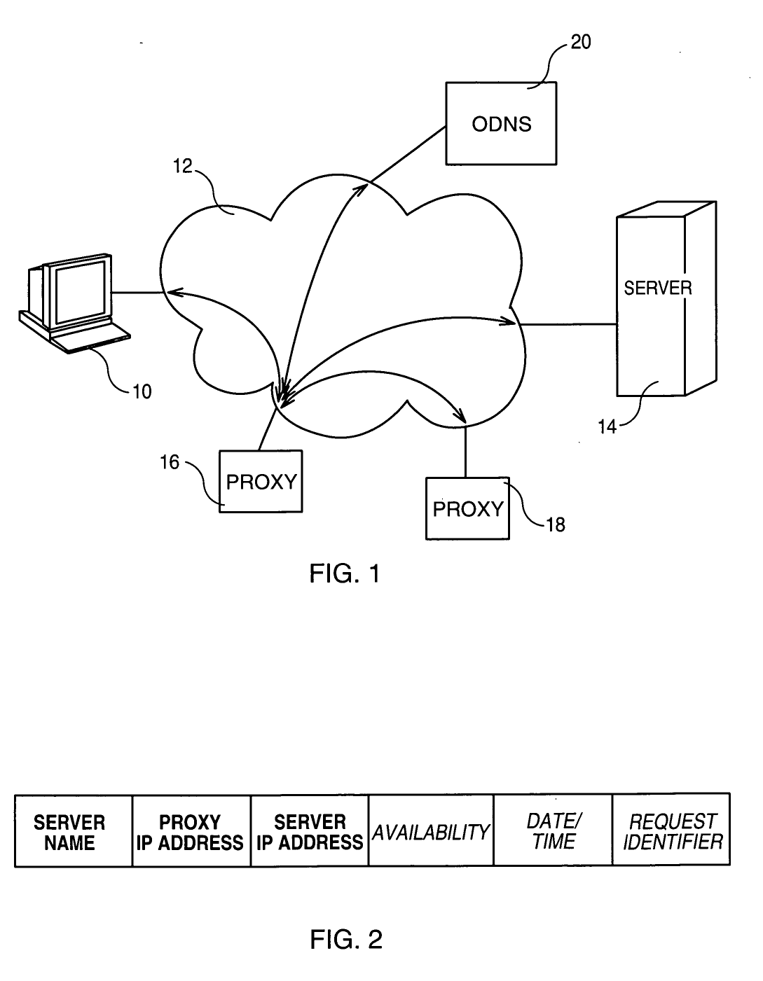

To provide the IP address of the content server, the Optimized DNS (ODNS) 20 has a table giving the IP address of the server for each server name. Each entry of the table as illustrated in FIG. 2 contains the following information:
Server name, which is the fully qualified name to be translated into an IP address and which is contained in the URL sent by the user,
A proxy IP address, which is the address of a proxy in which the requested data has previously been stored,
The IP address of the content server, the name of which is the host name known by the user.

This table could be extended for administration or statistic purposes with, for example, the following fields:
Availability, which indicates whether the content server is available or whether its access is refused,
Date/time, which is the date and time of the previous request which was addressed to the same data,
The identifier of the previous request.

It must be noted that there is not always an entry in the Optimized DNS table corresponding to the content server name. When such an entry exists in the table, the Optimized DNS can return the corresponding IP server address. Assuming that there is a proxy IP address corresponding to the host name contained in the request, this address is returned to proxy 16, which can send the request directly to a proxy such as the proxy device 18, which may contain the requested data, without sending the request to the content server.

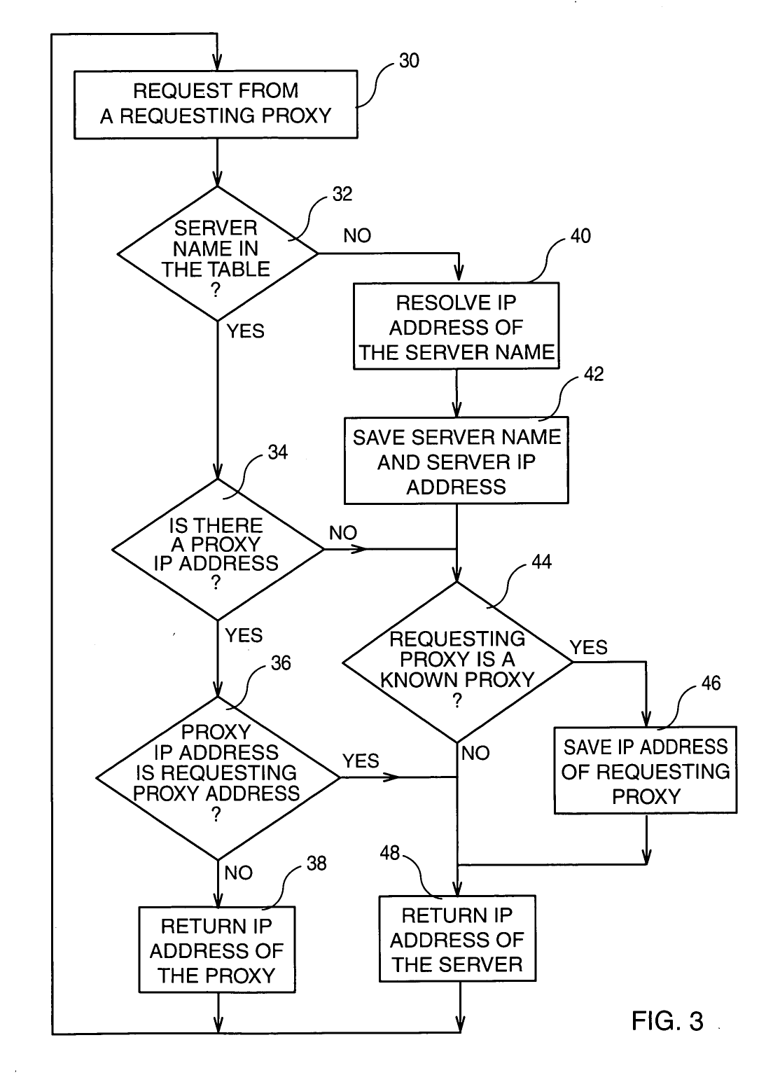

The steps of the method according to the invention implemented in the Optimized DNS 20 are now described in reference to FIG. 3. First, in step 30, the ODNS 20 is waiting for a request from the proxy associated with the user, that is proxy 16 in FIG. 1, which is called the requesting proxy in the following discussion. It is then determined whether the ODNS table contains an entry corresponding to the server name defined in the request (step 32). If so, it is determined whether this entry contains a proxy IP address in column 2 of the ODNS table (step 34). If so, it is determined whether the IP address of the proxy indicated in the table is the address of the proxy which has sent the request, that is proxy 16 of FIG. 1 (step 36). If it is not the case, the IP address of the proxy mentioned in the table is returned to the requesting proxy (step 38). As already mentioned, the proxy, that is proxy 16, can then address the proxy corresponding to the proxy having this IP address to obtain the requested data. Then, the process is looped back to the first step 30 of waiting for a new request.

Going back to Step 32, when the server name indicated in the request is not an entry of the table, the ODNS provides the request to another DNS of a hierarchy of DNS's, taking into account the tree structure of this hierarchy based upon the subnets defined in the domain name up to the root of the structure (step 40). Normally, this resolve step, which is not a part of the invention, enables an IP address corresponding to the server name defined in the request to be obtained. Then, a new entry is added to the ODNS table, such entry being the server name with the corresponding IP address of the server name (step 42).

When the new server name and its corresponding IP address have been saved in the table (step 42) or when there is an entry corresponding to the requested server name, but no proxy IP address in the ODNS table (see step 34), it is determined whether the requesting proxy (proxy 16 in FIG. 1) is a known proxy cache (step 44). A proxy is known if it is included in a list of proxies which is provided to the ODNS when the ODNS is configured. If the requesting proxy is known, its IP address is added in the entry of the table corresponding to the server name of the request (step 46). It must be noted that, at this stage, there is always an entry with the server name of the request, which was already in the table but without any proxy IP address in column 2 or which has been added in the table (step 42).

If the IP address of the proxy corresponding to the server name of the request is the IP address of the requesting proxy (step 36), or if it has been determined that the requesting proxy is not a known proxy (step 44), or if the IP address of the requesting proxy which was known by the ODNS has been added to the table (step 46), the IP address of the content server is returned to the requesting proxy (step 48).

Note that, in case the proxy address in the entry of the table which corresponds to the server name is the requesting proxy, this means that this proxy has already sent a request to the content server. In this case, this proxy has probably been reinitialized since this request and, therefore, has lost all the data contained in its cache, and accordingly, it is necessary to send to the requesting proxy the address of the content server.

At the initialization of the system according to the invention, all the proxies are declared to the ODNS so that the ODNS has a list of proxies as mentioned above. The configuration declaration includes the IP addresses of the proxies to be managed and the capabilities of the proxies. To start the system, all the caches are empty so that the ODNS can optimize how the proxy will be fulfilled and send the request to the right proxy.

1. Data transmission system comprising at least a data transmission network based upon an IP protocol, at least a content server for providing data requested by a user connected to the network, a plurality of proxies having a cache function, each proxy capable of having stored the requested data and one of the proxies being a user proxy to which is addressed the request sent by the user, and a domain name server for converting a server name provided by the user to the user proxy into an IP address of the content server;
wherein the domain name server includes table means for providing an IP address of a proxy amongst the proxies capable of having stored the requested data, the table means providing the proxy IP address to the user proxy whereby the requested data can be provided to the user by the proxy storing the requested data without requesting the data from the content server.

2. Method for obtaining data in an optimized way in a data transmission system comprising at least a data transmission network based upon an IP protocol, at least a content server for providing data requested by a user connected to the network, a plurality of proxies having a cache function, each proxy capable of having stored the requested data and one of the proxies being a user proxy to which is addressed the request sent by the user, and a domain name server for converting a server name provided by the user to the user proxy into an IP address of the content server;
the method including the steps of:
a) looking for an entry of a table stored in the domain name server corresponding to the server name when the user proxy has not stored the data requested by the user, and
b) determining, when there is such an entry in the table, whether the entry includes an address of a proxy amongst the plurality of proxies.

3. Method according to claim 2, further comprising the steps of:
c) returning the proxy IP address to the user proxy if such a proxy IP address is included in the entry corresponding to the server name, and
d) sending the user request from the user proxy to the proxy IP address included in the entry.

4. Method according to claim 2, further comprising a step of determining whether the user proxy is a known proxy when the entry in the table does not include the address of a proxy, the user proxy being a known proxy when it is contained in a list of proxies provided to the domain name server at an initialization of the system.
